(19) United States
(12) Patent Application Publication
(10) Pub. No.: US 2002/0034176 A1
(43) Pub. Date: Mar. 21, 2002

(54) Communication system providing remote user with facilities

(76) Inventor: Gerardus Vincentius Johannes Van Den Berg, Hilversum (NL)

Correspondence Address: Corporate Patent Counsel, U.S. Philips Corporation, 580 White Plains Road, Tarrytown, NY, 10591, US

(21) Appl. No.: 09/940,048

(22) Filed: Aug. 27, 2001

(30) Foreign Application Priority Data
Aug. 29, 2000 (EP) 00203011.2

(51) Int. Cl. H04L 12/66; H04J 3/16

(52) U.S. Cl. 370/352; 370/466

(57) ABSTRACT

A communication system (1) for example a voice and/or data system, has at least one user terminal (T1 . . . Tn), a facility providing processing device (2) coupled thereto for connecting the user terminals (T1 . . . Tn), and an intervening network (3) for interconnection of the processing device (2) and a remote user terminal (RT1 . . . RTm). The intervening network (3) is arranged for conveying at least facility related signals (S), and the processing device (2) is equipped for allowing its facilities to be used by the remote user terminal (RT1 . . . RTm). An appropriate signalling protocol, such as with DTMF tones can be used to communicate the facility related signals (S) through the intervening network (3), between the processing device (2) and the remote user termnal (RT1 . . . RTm).

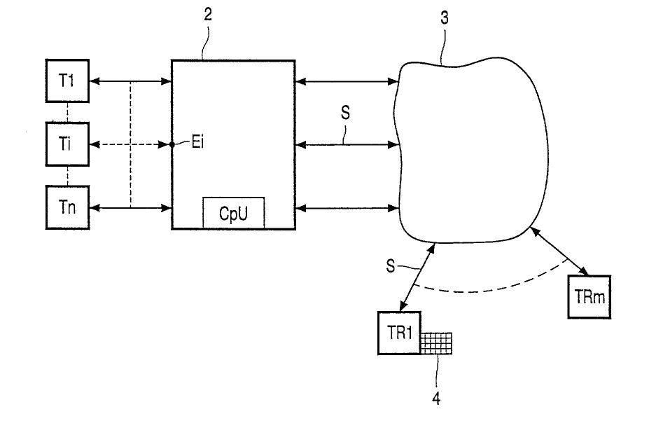

The present invention relates to a communication system for example a voice and/or data system, having at least one user terminal, a facility providing processing device coupled thereto for connecting the user terminals, and an intervening network for interconnection of the processing device and a remote user terminal.

The present invention also concerns in particular a telephone system comprising such a communication system.

Such a communication device is known from WO 97/18662. The system known therefrom has a plurality of computer user terminals which are coupled to a switching device which provides a virtual presence facility. An intervening public switched telephone network is interconnected between the switching device and a possibly remote access user terminal. The known system simulates -in a virtual presence server- to a co-worker or external party the virtual presence of a user at the premises of an corporate office, where the switching device is situated, in particular if the user is not present at the office. The virtual presence server also performs call management functions. There is however a variety of additional other facilities and functions which are not at the disposal of a remote user.

Therefore it is an object of the present invention to provide an improved communication system or telephone system, which is capable of offering these additional facilities to in particular remote users in the communication system.

Thereto the communication system according to the present invention is characterised in that the intervening network is arranged for conveying at least facility related signals, and that the processing device is equipped for allowing its facilities to be used by the remote user terminal.

It is an advantage of the communication system according to the present invention that the either or not remote user terminals may be equipped with generally known and state of the art hardware and/or software. Despite thereof interaction of the user terminals with all kinds of intervening networks is possible, while use of the facilities provided by the processing device can now also be made by in particular a remote user, as long as the intervening network is arranged for conveying facility related signals which are necessary for performing the facilities concerned. Examples of such intervening networks are: GSM-like networks, glass fiber networks, cable or wire networks, such as CAI networks, INTERNET, etcetera. Advantageously selectable facilities are also available to an external party, in particular the remote user when connected to the facility providing processing device only, that is wherein no connection to another user terminal has yet been made.

An embodiment of the communication system according to the invention is characterised in that the communication system is arranged for processing facility related signals during an active connection between the remote user terminal and another user terminal.

It is an advantage of this embodiment of the communication system according to the present invention that even during an active connection between the remote user terminal and any other user terminal, at least a remote user is capable of operating and/or calling those facilities or features which he or she desires to make use of at that particular moment during an ongoing call. This provides an extra service to the remote user during the call.

Another embodiment of the communication system according to the invention is characterised in that the intervening network supports a signalling protocol for conveying the facility related signals.

In a preferred embodiment the communication system according to the invention is characterised in that the facility providing processing device is arranged to have the facilities implemented by software and/or hardware.

Particularly the software implementation allows a advantageous flexibility and programmability of wanted facilities, without hardware burden.

Apart from measuring signals, operating signals and possible statistical signals, which are related to the facilities in a still further embodiment of the communication system according to the invention at least part of the facility related signals is arranged to select facilities requested by the remote user terminal.

An easy to implement embodiment of the communication system according to the invention is characterised in that either voice-like signals, e.g. DTMF control signals, FSK signals and the like, and/or end-to-end signals, e.g. user-to-user signalling are used for enabling the facilities of the processing device to the remote user terminal.

Advantageously a wide variety of general or more specific features may at wish be implemented in the communication system according to the invention, such as generic extension features, e.g. break-in feature, automatic ring back feature, follow me feature, shuttle feature, call forwarding; digital extension features, such as ISDN and data communication features; cordless extension features; group features; manager/secretary features; operator features; day and night service features; trunk features, e.g. generic trunk features, ISDN trunk features, and routing features; paging features; telephony and maintenance features; and any features upgradable and/or downloadable during operation of the communication system.

A practical embodiment of the communication system according to the invention is characterised in that the processing device and/or the user terminal concerned comprises a voice signal transmitter and/or receiver, for example a DTMF transmitter/receiver.

At present the communication system according to the invention will be elucidated further together with its additional advantages while reference is being made to the appended drawing. In the drawing the sole FIGURE shows a general outline of a possible embodiment of the communication system according to the present invention.

The FIGURE shows a communication system 1, which may be a voice and/or data communication system, such as a telephone system, either wired or cabled, or acting through RF or microwave transmitters and/or receivers, or satellites. Generally voice signals and data signals, apart from related control signals will be communicated throughout the system 1. The communication system 1 has at least one facility providing processing device 2, which is coupled to one or more user terminals T1 . . . Tn and has one or more so called remote user terminals RT1 . . . RTm, which are coupled to the processing device 2 through at least an intervening network 3. A user terminal Ti of the user terminals T1 . . . Tn enters the processing device 2 at a fixed entry Ei. The facility providing processing device 2 is capable of making a telephone and/or data connection to any other of the user terminals, and if the other user terminal also enters the processing device 2 at another fixed entry or vise versa, than generally all relevant features or facilities provided by the facility providing processing device are available at both user terminals. However in general a remote user terminal, whose connection through the intervening network 3 to the processing device 2 is made at an entry which is not fixed but depends on a designation by the device 2, will not have these features at his remote disposal.

Examples of the facilities and features meant here are: generic extension features, such as abbreviated dialling—on individual basis or on basis of use, group, or common pool—, conferencing features, break-in features, automatic ring back features—on busy, on next use (that is at return)—follow me features, shuttle features, call forwarding, do not disturb, hot-line, selective diversions, secret calls. Further features are for example: extension dialling features, password protected dialling, cost centre dialling, direct dialling out, (delayed) dialling out, last external number dialling, secret call dialling, extension ringing features, twinning (that is the call is routed to two destinations, when both are free), multiple ring group, call pick-up, queuing of incoming calls, three party features, add-on conference feature, multi-party conferencing features (more than three parties), diversion features—unconditional, on busy, on don't answer, on absent, on not reachable, on initiator, on basis of do not disturb—. Just by way of non limiting example the automatic ring back features will be elucidated further, as to include automatic ring back (ARB): on busy, on next use (that is at return) cancel ARB, multiple ARB, ARB protected, ARB after diversion(s). Also mentioned here—as far as applicable—are for example digital extension features, such as ISDN and data communication features; cordless extension features; group features; manager/secretary features; operator features; day and night service features; trunk features, e.g. generic trunk features, ISDN trunk features, and routing features; paging features; telephony and maintenance features. These features can at wish be upgraded and/or downloaded during operation of the communication system 1 from for example the processing device 2, the intervening network 3, or can be upgraded and/or downloaded from for example the INTERNET or from any data carrier source, such as compact disk available. Although the features may be implemented by software and/or hardware, the former will be preferred because of the flexibility and programmability provided thereby.

The intervening network 3, which may for example be a GSM-like network, glass fiber network, cable or wire network, such as CAI network, INTERNET or the like is typically arranged for conveying at least signals which are related to the mentioned facilities. In addition the processing device 2 is equipped for allowing its facilities to be used by at least any of the remote user terminal TR1 . . . TRm. If the remote user terminal is now actually connected to the processing device 2 through the one or more intervening networks 3 certain features may be called and actuated by the remote user. The same holds if the remote user terminal is actually connected in generally a telephone and/or data call to any other user terminal or remote terminal. Some appropriate connect signalling protocol for conveying the correspondingly facility related signals S to and from the remote user and processing device 2 may at wish be used.

In practice at least part of the facility related signals S is arranged to select facilities requested by the remote user terminal in the signalling protocol.

The signalling protocol uses signals which may be voice-like signals, e.g. DTMF control signals, FSK signals and the like, and/or end-to-end signals, e.g. user-to-user signalling for enabling the facilities of the processing device 2 to the remote user terminal TR1 . . . TRm. The processing device 2 and/or the user terminal T1 . . . Tn concerned comprises a voice signal transmitter and/or receiver, for example a DTMF transmitter/receiver 4. Such a transmitter and/or receiver is already present in nowadays telephone devices and is advantageously also given a very useful function in relation to the above mentioned facilities and features, which the remote user terminal RT1 . . . RTm has now at its disposal. A transmitter alone is already used for listening to voice mails, and/or for ordering products. The facilities can be enabled by the remote user in case the remote user is only connected to the processing device 2, but can even be enabled in cases wherein the remote user is actually connected in a call with some other user terminal.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person.

1. A communication system (1) for example a voice and/or data system, having at least one user terminal (T1 . . . Tn), a facility providing processing device (2) coupled thereto for connecting the user terminals (T1 . . . Tn), and an intervening network (3) for interconnection of the processing device (2) and a remote user terminal (RT1 . . . RTm), characterised in that the intervening network (3) is arranged for conveying at least facility related signals (S), and that the processing device (2) is equipped for allowing its facilities to be used by the remote user terminal (RT1 . . . RTm).

2. The communication system (1) according to claim 1, characterised in that the communication system (1) is arranged for processing facility related signals (S) during an active connection between the remote user terminal (RT1 . . . RTm) and another user terminal (T1 . . . Tn; RT1 . . . RTm).

3. The communication system (1) according to claims 1 or 2, characterised in that the intervening network (3) supports a signalling protocol for conveying the facility related signals (S).

4. The communication system (1) according to one of the claims 1-3, characterised in that the facility providing processing device (2) is arranged to have the facilities implemented by software and/or hardware.

5. The communication system (1) according to one of the claims 1-4, characterised in that at least part of the facility related signals (S) is arranged to select facilities requested by the remote user terminal (RT1 . . . RTm).

6. The communication system (1) according to one of the claims 1-5, characterised in that either voice-like signals, e.g. DTMF control signals, FSK signals and the like, and/or end-to-end signals, e.g. user-to-user signalling are used for enabling the facilities of the processing device (2) to the remote user terminal (RT1 . . . RTm).

7. The communication system (1) according to one of the claims 1-6, characterised in that the facilities may comprise one or more of the following features: generic extension features, e.g. break-in feature, automatic ring back feature, follow me feature, shuttle feature, call forwarding; digital extension features, such as ISDN and data communication features; cordless extension features; group features; manager/secretary features; operator features; day and night service features; trunk features, e.g. generic trunk features, ISDN trunk features, and routing features; paging features; telephony and maintenance features; and any features upgradable and/or downloadable during operation of the communication system (1).

8. The communication system (1) according to one of the claims 1-7, characterised in that the processing device (2) and/or the user terminal (T1 . . . Tn) concerned comprises a voice signal transmitter and/or receiver, for example a DTMF transmitter/receiver (4).

9. Telephone system comprising a communication system (1) according to one of the claims 1-8, the communication system (1) having at least one user terminal (T1 . . . Tn), a facility providing processing device (2) coupled thereto for connecting the user terminals (T1 . . . Tn), and an intervening network (3) for interconnection of the processing device (2) and a remote user terminal (RT1 . . . RTm), characterised in that the intervening network (3) is arranged for conveying at least facility related signals (S), and that the processing device (2) is equipped for allowing its facilities to be used by the remote user terminal (RT1 . . . RTm).
